(19) United States
(12) Patent Application Publication
(10) Pub. No.: US 2026/0316700 A1
(43) Pub. Date: Oct. 15, 2026

(54) Body Component for a Body of an at Least Partially Electrically Operated Motor Vehicle, Motor Vehicle and Method for Mounting a Body Component

(71) Applicant: Bayerische Motoren Werke Aktiengesellschaft, Muenchen (DE)

(72) Inventors: Jochen ENGEL, Muenchen (DE); Niko FONTEIN, Unterschleissheim (DE); Daniel HOSTA, Muenchen (DE); Martin MITTERMAIER, Muenchen (DE); Markus VOCK, Garching (DE)

(21) Appl. No.: 19/484,900

(22) PCT Filed: Apr. 29, 2024
(86) PCT No.: PCT/DE2024/100385

§ 371 Date: Nov. 17, 2025

(30) Foreign Application Priority Data
May 22, 2023 (DE) 10 2023 113 253.9

(51) Int. Cl. B60R 16/02; B60L 53/18

(52) U.S. Cl. CPC B60R 16/0215; B60L 53/18

(57) ABSTRACT

A body component for a body of an at least partially electrically operated motor vehicle has at least one first side which, in the assembled state of the motor vehicle, faces an interior of the motor vehicle, and a second side which, in the assembled state of the motor vehicle, faces surroundings of the motor vehicle. At least between the first side and the second side, an installation space is formed. In the installation space, a sound insulation element faces the first side and a charging line for charging an electrical energy store of the motor vehicle faces the second side. A motor vehicle and a method for mounting a body component are also disclosed.

### BACKGROUND AND SUMMARY

The invention relates to a body component for a body of an at least partially electrically operated motor vehicle, having at least a first side which, in the assembled state of the motor vehicle, faces an interior of the motor vehicle, and having a second side which, in the assembled state of the motor vehicle, faces surroundings of the motor vehicle, wherein an installation space is formed at least between the first side and the second side. The invention also relates to a motor vehicle having a body component and a method for mounting a body component.

At least partially electrically operated or fully electrically operated motor vehicles are already known from the prior art. These have an appropriate charging interface in which, for example, AC charging or DC charging can be carried out. For this purpose, a plug device, for example from a charging column, is plugged into a corresponding charging socket on the motor vehicle. Corresponding charging lines are then in turn provided from the charging socket to the electrical energy store. Because of electrical losses, it is possible for heating of the corresponding charging line in the motor vehicle to occur.

According to the prior art, these charging lines are accordingly installed, for example, in the body component, for example on a C-pillar of the motor vehicle. In the prior art, these face the interior of the motor vehicle, as a result of which it is possible for heating of the internal body components to occur, which, for example, can lead to a negative development of heat for an occupant.

DE 10 2013 008 801 A1 describes a vehicle, in particular a land vehicle, having at least one vehicle interior, at least one drive unit, in particular an electric motor of an electric drive, at least one traction battery, at least two coolant circuits and at least one refrigerant circuit, wherein the first coolant circuit operates at a first temperature level and the second coolant circuit operates at a second temperature level that is different from the first temperature level, and wherein the first coolant circuit is used for air-conditioning the vehicle interior and/or for cooling at least one unit, in particular the electric motor, and the second coolant circuit is used for controlling the temperature of the traction battery, and the refrigerant circuit is used for air-conditioning the vehicle interior and for absorbing heat from the second coolant circuit, wherein the second coolant circuit for controlling the temperature of the traction battery comprises at least a first cooling device, a second cooling device and a heating device, wherein the first and the second cooling device and the heating device of the second coolant circuit can be operated independently of one another.

The object of the present invention is to devise a body component, a motor vehicle and a method for mounting a body component by means of which the undesired development of heat in the interior of the motor vehicle can be prevented.

This object is achieved by a body component, a motor vehicle and a method for mounting a body component according to the independent patent claims. Advantageous embodiments are specified in the dependent claims.

One aspect of the invention relates to a body component for a body of an at least partially electrically operated motor vehicle, having at least a first side which, in the assembled state of the motor vehicle, faces an interior of the motor vehicle, and having a second side which, in the assembled state of the motor vehicle, faces surroundings of the motor vehicle, wherein an installation space is formed at least between the first side and the second side.

Provision is made that, in the installation space, sound insulation faces the first side and a charging line for charging an electrical energy store of the motor vehicle faces the second side.

In particular, for example during fast charging of the electrical energy store, the charging line can accordingly emit heat because of an electrical resistance, which in particular can be perceived negatively by an occupant in the interior. Provision is then made for the sound insulation also to form thermal insulation for the charging line with respect to the interior. Thus, the sound insulation is given dual functionality, specifically firstly, for example, to appropriately insulate noise from the surroundings of the motor vehicle, in particular external surroundings of the motor vehicle, and at the same time also to form thermal insulation for the charging line, so that no unintended input of heat into the interior of the motor vehicle can be registered.

In particular in the following exemplary embodiment, the first side and the second side are formed substantially opposite each other. The first side and the second side can be made of metal, for example of aluminum. A hollow space, which corresponds to the installation space, is formed between the first side and the second side. Within the installation space, viewed from the interior toward the surroundings, the first side, then the sound insulation, then the charging line and then the second side are then formed.

In particular, the invention thus has the advantages that additional measures for the thermal insulation of the charging line are not needed, since the sound insulation, which is already installed as standard, assumes a dual function and thus insulates the sound and also forms thermal insulation with respect to the interior. As a result, the heat can be dissipated appropriately, for example into the outer area of the motor vehicle. Acoustic disadvantages are nevertheless not to be registered, since the sound insulation continues to absorb the sound for the interior. In other words, the heat is removed from the charging line into the outer area or into the surroundings of the motor vehicle via the body.

According to an advantageous embodiment, an AC charging line is additionally arranged in the installation space. In particular, for example, the electrical energy store can be charged appropriately both via DC charging and via AC charging. In order then to utilize the installation space better, for example a DC charging line can be provided as the charging line and an AC charging line. Thus, the body component can be provided highly functionally and enable both DC charging and AC charging for a user.

Furthermore, it has proven to be advantageous if a cable harness is additionally arranged in the installation space. For example, the cable harness can comprise electric lines for further loads, for example lights, cameras or data lines. The installation space is thus used in order to be able to carry these corresponding lines as well.

A further advantageous embodiment provides for the AC charging line and/or the cable harness to face the first side. In particular, the AC charging line and/or the cable harness thus face the interior of the motor vehicle. In particular, only a small thermal loading is to be registered during charging with AC. The cable harness with corresponding data cables also produces only a small amount of heat. It is thus advantageous for these accordingly to face the interior, so that these are, for example, protected against external influences such as cold or the like.

It is likewise advantageous if the charging line is a DC charging line. The DC charging line is in particular suitable for fast charging of the motor vehicle, for which purpose, for example, charging outputs of up to 350 kW flow via this DC charging line. This leads to the charging line heating up correspondingly. By means of the DC charging line, fast charging of the motor vehicle or of the electric energy store is thus made possible, wherein by means of the appropriate arrangement, in particular facing the outside of the motor vehicle, no thermal inputs into the interior of the motor vehicle are to be registered.

A further advantageous embodiment provides for the body component to be a load-bearing vehicle pillar of the motor vehicle. For example, the load-bearing vehicle pillar can be an A-pillar, a B-pillar or C-pillar. Within this structure, it is advantageous to use the corresponding installation space in order to install the corresponding components there. Thus, installation space in the motor vehicle can be saved.

It is also advantageous if the body component comprises a wheelhouse of the motor vehicle, at least in some areas. In particular, the body component can comprise, for example, the C-pillar and, to some extent, the rear wheelhouse. In particular in motor vehicles in which an appropriate charging socket is to be recorded in the rear area of the motor vehicle, this thus has the advantage that installation space can be used appropriately.

It is likewise advantageous if the sound insulation is sound insulation for the wheelhouse. It is already known that appropriate sound insulation is already built up in relation to the wheelhouse, since appropriate insulation is needed precisely there because of running noise from the wheel. This sound insulation can now be used to perform thermal insulation as well. Thus, the sound insulation of the wheelhouse is given dual functionality.

A further aspect of the invention relates to a motor vehicle having a body component according to the preceding aspect. The motor vehicle can be designed as an at least partially electrically operated motor vehicle or else preferably as a fully electrically operated motor vehicle.

A still further aspect of the invention relates to a method for mounting a body component according to the preceding aspect, comprising the steps: providing the second side of the body component, arranging the charging line on the second side, arranging the sound insulation on the charging line and arranging the first side of the body component on the sound insulation. The steps are preferably carried out in the order mentioned above.

Advantageous embodiments of the body component are to be regarded as advantageous embodiments of the motor vehicle. Furthermore, advantageous embodiments of the body component are also to be regarded as advantageous embodiments of the mounting method.

Further features of the invention can be gathered from the claims, the figures and the figure description. The features and feature combinations mentioned previously in the description and the features and feature combinations mentioned below in the figure description and/or shown on their own in the figures can be used not only in the respectively specified combination but also in other combinations or on their own.

The invention will now be explained in more detail by using a preferred exemplary embodiment and with reference to the drawings.

### BRIEF DESCRIPTION OF THE DRAWINGS

FIG. 1 is a schematic perspective view of an embodiment of a body component; and

FIG. 2 is a schematic sectional view of an embodiment of the body component according to FIG. 1.

In the figures, the same or functionally identical elements are provided with the same reference signs.

### DETAILED DESCRIPTION OF THE DRAWINGS

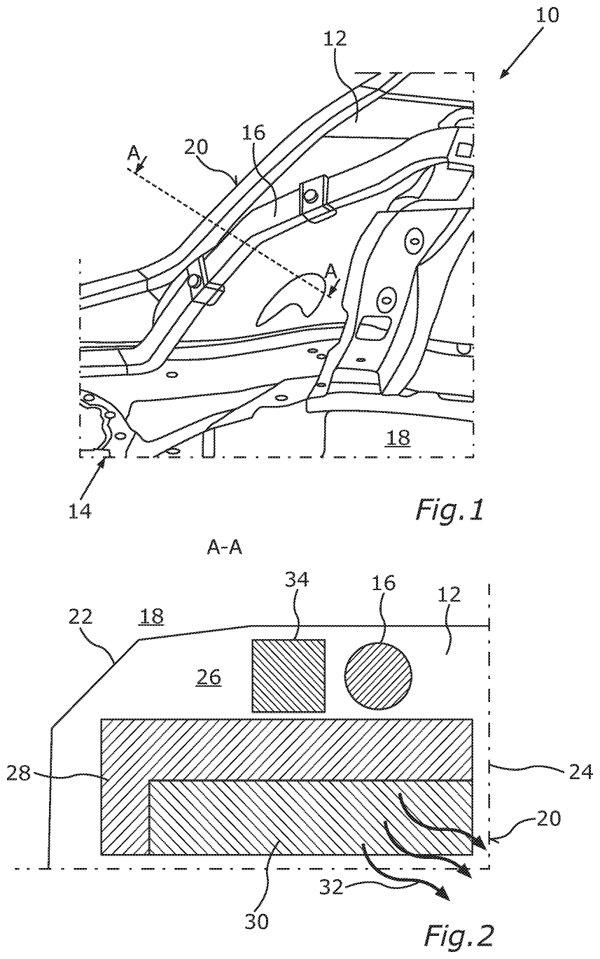

FIG. 1 shows a schematic perspective view according to one embodiment of a motor vehicle 10 having a body component 12. In the following exemplary embodiment, the body component 12 is in particular designed as a C-pillar of the motor vehicle 10. Furthermore, FIG. 1 shows a wheelhouse 14 of the motor vehicle 10. FIG. 1 also shows a cable harness 16. In particular, a view of the motor vehicle 10 from an interior 18 of the motor vehicle 10 is thus shown in FIG. 1. In addition, FIG. 1 also shows an outer side 20, which in particular faces away from the interior 18. The outer side 20 faces outer surroundings of the motor vehicle 10, for example.

Furthermore, FIG. 1 shows a section plane A-A which, in FIG. 2, is appropriately expanded with the arrangement according to the invention.

FIG. 2 shows a schematic sectional view according to one embodiment of the body component 12. In the present exemplary embodiment, as compared with FIG. 1, the sectional illustration A-A is shown, wherein the body component 12 is extended according to the invention in the present case.

FIG. 2 shows in particular the body component 12 for the at least partially electrically operated motor vehicle 10. The motor vehicle 10 can also preferably be fully electrically designed. To this end, the motor vehicle 10 in particular has an electrical energy store, not illustrated. The body component 12 has at least a first side 22 which, in the assembled state of the motor vehicle 10, faces the interior 18 of the motor vehicle 10. Furthermore, FIG. 2 shows a second side 24, which substantially faces the outer side 20. In particular, an installation space 26 is formed between the first side 22 and the second side 24. Provision is made that in the installation space 26, sound insulation 28 faces the first side 22 and a charging line 30 faces the second side 24. In the present exemplary embodiment, the charging line 30 is in particular designed as a DC charging line for the fast charging of the electrical energy store. As a result, heat 32 that is produced in the charging line 30 during the fast charging is dissipated via the second side 24 into the surroundings of the motor vehicle 10.

FIG. 2 also shows that an AC charging line 34 and the cable harness 16 can additionally be arranged in the installation space 26. Provision can preferably be made for the AC charging line 34 and the cable harness 16 to face the first side 22. Furthermore, provision can be made, as shown in FIG. 1, for the body component 12 to be a load-bearing vehicle pillar of the motor vehicle 10. Furthermore, the body component 12 can also comprise the wheelhouse 14, at least in some areas. The sound insulation 28 can in particular be the sound insulation 28 for the wheelhouse 14.

In particular, FIG. 2 thus shows a novel type of installation order. The sound insulation 28 is given an additional function and the task of thermal insulation with respect to the interior 18 and thus with respect to an occupant of the motor vehicle 10. The charging line 30 is mounted first, the sound insulation 28 over the former, and thus has a dual action.

In particular, FIG. 2 thus also shows a method for mounting the body component 12, wherein the second side 24 is provided, the charging line 30 is then arranged on the second side 24, whereupon the arrangement of the sound insulation 28 on the charging line 30 is carried out. The arrangement of the first side 22 then follows. These steps can of course also be expanded further in order, for example, to arrange further objects there in the installation space 26, such as for example the AC charging line 34 and the cable harness 16. Thus, the mounting order is not final and can be supplemented by additional steps.

### LIST OF REFERENCE SIGNS

10 Motor vehicle
12 Body component
14 Wheelhouse
16 Cable harness
18 Internal space
20 Outer side
22 First side
24 Second side
26 Installation space
28 Sound insulation
30 Charging line
32 Heat
34 AC charging line

1.-10. (canceled)

11. A component for a body of an at least partially electrically operated motor vehicle, comprising:
a body component having at least a first side which, in an assembled state of the motor vehicle, faces an interior of the motor vehicle, and having a second side which, in the assembled state of the motor vehicle, faces surroundings of the motor vehicle;
an installation space formed at least between the first side and the second side;
sound insulation arranged in the installation space facing the first side; and
a charging line for charging an electrical energy store of the motor vehicle arranged in the installation space facing the second side.

12. The component according to claim 11, further comprising:
an AC charging line additionally arranged in the installation space.

13. The component according to claim 12, further comprising:
a cable harness additionally arranged in the installation space.

14. The component according to claim 13, wherein
the AC charging line and/or the cable harness face the first side.

15. The component according to claim 11, wherein
the charging line is a DC charging line.

16. The component according to claim 11, wherein
the body component is a load-bearing vehicle pillar of the motor vehicle.

17. The component according to claim 11, wherein
the body component comprises a wheelhouse of the motor vehicle, at least in some areas.

18. The component according to claim 17, wherein
the sound insulation is sound insulation for the wheelhouse.

19. A motor vehicle comprising a body component according to claim 11.

20. A method for mounting a body component of an at least partially electrically operated motor vehicle, comprising:
arranging a second side of the body component so as to face surroundings of the motor vehicle in an assembled state;
arranging a charging line for charging an energy store of the motor vehicle on the second side of the body component in an installation space;
arranging a sound insulation on the charging line in the installation space; and
arranging a first side of the body component on the sound insulation, the first side facing an interior of the motor vehicle in the assembled state, wherein the installation space is formed at least between the first side and the second side.
